(19) United States
(12) Patent Application Publication
(10) Pub. No.: US 2008/0092691 A1
(43) Pub. Date: Apr. 24, 2008

(54) Crank Mechanism

(75) Inventors: Karsten Wittek, Aachen (DE); Markus Kalenborn, Wurselen (DE); Carl Ritterskamp, Meerbusch (DE); Kolja Orlowsky, Aachen (DE)

Correspondence Address: GIFFORD, KRASS, SPRINKLE,ANDERSON & CITKOWSKI, P.C, PO BOX 7021, TROY, MI, 48007-7021, US

(73) Assignee: Fev Motorentechnik GMBH, Aachen (DE)

(21) Appl. No.: 11/718,810

(22) PCT Filed: Apr. 20, 2005
(86) PCT No.: PCT/EP05/04233

§ 371 Date: May 8, 2007

(30) Foreign Application Priority Data
Nov. 8, 2004 (DE) 10 2004 054 128.0
Apr. 14, 2005 (DE) 20 2005 005 999.4

(51) Int. Cl. F16C 3/08; F16C 7/02; F16C 9/02; F16C 9/04; B21K 3/00

(52) U.S. Cl. 74/579 E; 29/888.01

(57) ABSTRACT

The present invention relates to a crank mechanism, wherein the crank mechanism has a one-piece crankshaft and also at least three one-piece connecting rods, which are assembled together with each other in a non-destructive way. In addition, a system module of such a crankshaft, a production method, and also a system for producing the crank mechanism are proposed.

### CROSS-REFERENCE TO RELATED APPLICATIONS

This application is the U.S. National Phase Application of and claims priority to parent Application No. PCT/EP2005/004233 filed Apr. 20, 2005, which claims priority to German Application No. 202005005999.4 filed Apr. 14, 2005 and German Application No. 102004054128.0 filed Nov. 8, 2004.

### FIELD OF THE INVENTION

The present invention relates to a crank mechanism, particularly for a combustion engine of a motor vehicle, and also to a system for producing a crank mechanism, particularly for a combustion engine of a motor vehicle.

### BACKGROUND OF THE INVENTION

It is known that a crankshaft offers special operating reliability if it is produced in one piece. For example, a crankshaft of an internal combustion engine, which can be used in motor vehicles but also in locomotives and railway engines is known from CH 294835. The crankshaft is produced in one piece and combined with roller bearings.

### SUMMARY OF THE INVENTION

The task of the present invention is to make available an improved crank mechanism.

This task is achieved with a crank mechanism with the features of Claim 1, with a system module with a crank mechanism with the features of Claim 17, with a method for mechanism with the features of Claim 29. Additional advantageous constructions and applications of the invention emerge from the dependent claims and also in more detail from the following description.

According to the invention, a crank mechanism, particularly for a combustion engine of a motor vehicle, features a one-piece crankshaft and also at least three one-piece connecting rods, which are assembled together in a non-destructive way.

A system according to the invention for producing a crank mechanism, particularly for producing a combustion engine of a motor vehicle, provides the following stations: production of a one-piece crankshaft, production of at least three one-piece connecting rods, a first station for combining the one-piece connecting rods and the one-piece crankshaft, and a second station for inserting the combination of connecting rods and crankshaft into a housing, particularly a crankcase.

The system with all of the stations can be assembled at one location, especially in a common production area. The individual stations, however, can also be provided separately from each other, for example, in different production facilities. Also, two stations can be integrated with each other. For example, the first and the second station can form a common production facility and thus cannot be separated further.

According to one improvement, the crank mechanism has at least one one-piece bearing block in which the crankshaft is supported. Preferably, the crank mechanism features only one-piece bearing blocks. This makes it possible, first, that not only the one-piece crankshaft but also each one-piece connecting rod can advantageously realize accuracy corresponding to that achieved in production due to the support in the one-piece bearing blocks. This means that such a crank mechanism on the one hand features a high resistance to wear since deviation from preset dimensions can be avoided due to the one-piece formation of the individual components. Second, frictional forces can be avoided due to the one-piece formation of the components. This prevents, in turn, wear on individual components moving relative to each other.

Advantageously, the crank mechanism is used, in particular, in a multiple-cylinder combustion engine. This features, for example, at least three cylinders. The one-piece crankshaft is used in a non-destructive way at least with one one-piece connecting rod, preferably with two and especially with three one-piece connecting rods.

Preferably, the crank mechanism has at least one rolling bearing for the crankshaft. According to one construction, the rolling bearing comprises at least one ball bearing and/or one roller bearing. According to another construction, the crankshaft is supported exclusively by rolling bearings. Again, it can be provided that the cranks mechanism has at least one rolling bearing and one sliding bearing for the crankshaft.

Advantageous constructions of rolling bearings for crankshafts emerge, for example, from DE 101 53 018 A1, from DE 199 26 406 A1, and also from DE 25 35 332 A1. These will be referred to in the scope of the disclosure of the invention with respect to the type of rolling bearing, the arrangement of movable bearings and fixed bearings, the bearing bodies that are used, and also the bearing materials and bearing structural parts that are used.

Preferably, ball bearings are used as the main bearings. These represent lesser requirements with respect to shape and positional accuracy, as exist, for example, for other rolling bearings, especially needle bearings. In contrast, if greater accuracy can be maintained with respect to shape and positional accuracy, but at the same time an increased force transfer by the bearings is required, then roller or needle bearings can also be used, in particular, also as main bearings. Preferably, only one groove is provided for a use of a ball bearing. Therefore, it is possible to eliminate a starting flat and also a channel together with a thrust bearing.

In particular, the rolling bearing, in particular the ball bearing, is first mounted on the crankshaft at the end. For this purpose, one or more components of the bearing, especially a cage, are segmented and can be assembled. For example, rolling bearing bodies, especially ball bearings, can first be introduced, at least in large part, into the bearing before closure and in particular positioning, for example, by means of a cage.

To allow the rolling bearing body to be inserted for a component of the rolling bearing already at least partially brought onto the crankshaft or onto a bearing seat, especially for an already placed inner and/or outer ring of the rolling bearing, for example, an insertion slot can be provided. This groove extends preferably from an edge region of the rolling bearing into an interior region of the rolling bearing. This has, for example, the shape of a ramp. The insertion slot can also be closed again according to one improvement, when the rolling bearing body has been inserted. For that purpose, for instance, a metal or plastic insert, in particular a strip, can be inserted in a form or force fit. The insert can also be screwed on. The insertion slot enables the rolling bearing body to still be introduced into the rolling bearing at a later time. In particular, this allows an assembly of the rolling bearing on the crankshaft in the way that, for example, the inner and the outer ring, as well as the cage are already preassembled. Then the rolling bearing can be filled. This allows, for example, for the use of a ball bearing, the use of more balls, and accordingly the possibility of distributing the ultimate load and therefore increasing the service life. Preferably, between 8 and 14 balls are used for a single-row ball bearing according to one construction. According to another construction, the rolling bearing should have a dynamic load rating C according to ISO 281 of at least 35 kn.

According to another construction, the rolling bearing has no insertion slot. Instead, in this case, the rolling bearing body is first inserted into the prepared bearing before the cage is inserted.

A first improvement provides that a roller bearing is used for a crank pin of the crankshaft and a ball bearing is used for a main bearing of the crankshaft. Preferably, this is used in small cars equipped with, for example, a three-cylinder combustion engine. A second improvement provides for sliding bearings to be provided for the connecting-rod bearings and rolling bearings are provided for the main bearings of the crankshaft. This is used especially for a combustion engine whose cylinders are arranged in a V shape. There, as also in other combustion engines with the one-piece crankshaft and the one or more one-piece connecting rods, a camshaft bearing can also be used which is likewise at least partially supported by rolling bearings. Preferably, the camshaft is completely supported by rolling bearings. In addition, in one combustion engine, for example, a fixed bearing is arranged where the clutch is closest. If, for example, a ball bearing and a thrust bearing are used as main bearings of the crankshaft, then in particular the larger of the two is arranged in the area of the clutch flange.

As rolling bearings, in particular, the following types of rolling bearings can be used individually or in combination with each other:

Thrust bearings, such as, for example

Single-row or double-row grooved ball bearings, for example, with a cover plate or a sealing plate or a retaining ring;
Angular contact ball bearings in single-row or double-row arrangements;
Self-aligning ball bearings, with, for example, cylindrical bore or with conical bore;
Cylindrical roller bearings, for example, in single-row or double-row arrangements, especially with cage;
Track roller bearings;
Needle bearings;
Detachable ball journal bearings;
   Radial bearings, such as, for example
Needle bearings;
Tapered roller bearings;
Barrel-shaped roller bearings;
Self-aligning roller bearings;
Needle ball bearings;
   as well as rolling bearing types that can receive, for example, axial and radial forces, such as, for example, a few of the bearings listed above and combinations thereof.

The rolling bearings can be arranged in an X, O, and/or also in a tandem arrangement.

For lubricating the rolling bearings, for example, a plunger pump can be used. This can replace, in particular, an otherwise possibly required oil pump for lubricating the crank mechanism. Lubrication can be enabled, for example, by means of an oil atomizer and/or an oil gun. For example, oil immersion lubrication, spray-oil lubrication, drip-oil lubrication, oil pressure lubrication, centrifugal lubrication, oil-mist lubrication, and/or oil injection lubrication can be provided. According to another construction, grease lubrication can also be used for at least one of the rolling bearings. Here, for example, a regulator for the quantity of grease is used. There is also the possibility of using sealed bearings at least in part.

Lubricating the connecting rods and main bearings is preferably effected by means of the oil mist in the crankcase. Thus, according to one construction, complicated bores into the crank web, feed lines to the main bearings, and also collection devices in the form of slinger rings or web notches can be eliminated. Preferably, the connecting rods are guided in pistons, especially as top guides, so that peripheral speeds at axial guide surfaces in the piston are significantly smaller, and there is only one pivoting motion. Through an axial clearance necessary for this motion in the connecting rod on the crank pin, which equals, in particular, at least 2 to 3 mm, and the good accessibility in the upper region of the crank pin, a sufficient supply of oil for the connecting-rod bearing can be guaranteed by an oil mist.

In the case of a connecting rod guided at the bottom, according to another construction the connecting rod can be either slotted at one part of the periphery, especially where a small load prevails, or it can have lubrication grooves at the side contact surfaces, in order to guarantee a sufficient supply of oil. Preferably, according to one improvement, an additional targeted spray oil lubrication onto the connecting-rod bearing is in a certain position. For this purpose, a branch can be provided from an existing piston cooling-oil nozzle that directs a second jet onto the crank pins located OT [top dead center].

The crankshaft main bearings, if they are not enclosed or are difficult to access, are preferably also lubricated with an oil mist. Because they are not exposed to centrifugal motion, the amount of oil necessary is significantly less than that of the connecting-rod bearing.

Thus, different lubrication concepts are possible as a function of the construction: the connecting rod can be guided axially at the top in the piston or at the bottom by the crankshaft. Lubricating the connecting-rod bearings and main bearings can be realized either as forced lubrication, especially spray/pressurized oil feeding, or through free lubrication, especially as an oil mist. Mixtures are also possible.

Materials for the bearings can be, for example, heat-resistant, non-rusting steels, cobalt alloys, and also ceramic materials. The cage material can likewise be made from these or from steel or brass. The cage can also be a sheet-metal cage. An additional material for the cage can be bronze, for example, a phosphorous bronze or also a ferrosilicon bronze. For a few applications, plastic can also be used, especially glass fiber-reinforced plastic, for example, glass fiber-reinforced polyamide 66.

Materials for the one-piece crankshaft but also for the non-divided connecting rods can be case-hardened or tempered steel. However, cast iron, for example, with cast bearing inner ring inserts can also be used. Bearing rings can be pressed, for example, into the connecting rod, so that this is available as an alternative for direct support. Therefore, non rolling bearing-capable materials, such as GG, GGG, ADI, or aluminum can also be used. According to one improvement, bearing rings made from roller-bearing steel are cast together with the connecting rod made from cast iron. One construction provides, for example, 15CrNi6 or 16MnCr5 as the material for a connecting rod, especially for direct support. For a crank pin, for example, 15Cr3 can be used.

Preferably, the tracks for the rolling bodies are hardened, especially case hardened. The case hardening depth lies, in particular, in a range between 0.4 mm and 1 mm.

In addition, the backlash, which is also called bearing play, can lie in a range between 60 μm and 300 μm, in particular with its respective minimum and maximum values, depending on the rolling bearing and crankshaft dimensions.

The crank mechanism is constructed, in particular, such that the crankshaft has a rounded section at its transition between a crankshaft journal and a web, such that the one-piece connecting rod can be guided past. In this way, one or more connecting rods can be threaded over the crankshaft. By moving the connecting rod in different directions, the opening provided for the connecting-rod bearing can be turned so that the openings can be guided over respective geometries of the crankshaft. For this purpose, the connecting rods can be turned about their axle-bearing axis in all possible directions.

According to another construction, counterweights are arranged on the crankshaft. Preferably, the counterweights are arranged as separate counterweights. One improvement provides for the counterweights to be screwed onto the crankshaft. Preferably, this is realized by means of at least two tensioning screws. The counterweights can then be arranged, for example, on the crankshaft when the one-piece connecting rod and also the bearing blocks are each connected to the crankshaft. For example, the rolling bearing blocks can be introduced and secured in a connecting-rod bearing and/or in a crankshaft bearing. A number of counterweights can be selected from the respective structural conditions and also the conditions of use of the crank mechanism. In particular, the number of screwed-on counterweights can be freely selected for each engine construction. For inline four-cylinder engines, according to one construction, for example, four or eight weights can be provided. Balancing of the crankshaft can be performed with weights during assembly. Likewise, an exclusive balancing of the crankshaft can also be performed. This is enabled when there are tight dimensional tolerances for the add-on parts.

An assembly of the crank mechanism can take place such that pistons of the combustion engine are first connected to the connecting rods and via these rods to the crankshaft, before the pistons are inserted into an appropriate cylinder. Another construction provides for the pistons of the combustion engine first to be inserted into an appropriate cylinder and brought into a defined position before the pistons are connected to the connecting rods, and via these rods to the crankshaft. There is also the possibility of first installing the connecting rods on the crankshaft and only then connecting the connecting rods to the pistons.

Preferably, main bearing rings and connecting rods are guided via the crankshaft into their appropriate positions. Then corresponding rolling bodies are inserted into the appropriate bearing. This also includes that corresponding cages are inserted into the bearings. Securing the rolling bodies can be effected by the cages themselves and also by other corresponding securing mechanisms.

A combustion engine of a motor vehicle, especially a four-cylinder combustion engine operating according to the Otto principle, has, for example, the following features: it has a one-piece crankshaft made from tempered steel with induction-hardened bearing tracks. Furthermore, the crankshaft has screwed-on counterweights. These are preferably eight counterweights. The one-piece connecting rods that are used are made from case-hardened steel. The bearing cages that are used are built from duralumin. A crankcase is provided into which the crank mechanism can be inserted, wherein the crankcase has separate, undivided bearing blocks. The spherical housing [sic; crankcase] is screwed to the cylinder head. Preferably no bearing tunnel processing is provided. The crank mechanism including the pistons is preferably assembled from below into the crankcase. Then the crankcase can be screwed to the cylinder head. In addition, a crosswise screw connection can be provided on an apron. Alternatively, there is also the possibility of screwing the bearing blocks that are used or the entire crank mechanism to the cylinder head.

For thermal declutch, it can be advantageous, for example, for the bearing blocks that are used to be made from a different material than that of, for example, the crankcase or the cylinder head. Thus, according to one construction, the bearing blocks are made from, for example, a non-aluminum or non-magnesium-containing material, while, for example, the crankcase does consist of these materials. A material for a bearing block can be a cast material or also a steel material. Also, a bearing block can have a two-or-more piece construction.

One improvement provides for a ladder frame to be used, which at least partially surrounds the crank mechanism in the combustion engine. Furthermore, bearing blocks can be arranged in the recesses in the crankcase provided for ventilation. A cylinder head screw connection can likewise use the bearing blocks, in that this either extends through the bearing blocks into the crankcase or its counterpart is located in corresponding screw connections in the bearing blocks.

A through hole screw connection can also be used for horizontally divided bearing blocks. The threading in this case is preferably arranged above a mold joint. Another construction provides a completely continuous screw connection with which the ladder frame can be screwed directly. This is also possible for both bearing blocks.

According to another concept of the invention, the non-divided crankshaft is machined such that a running-surface machining of journals is limited to milling and grinding of bearing grooves. Offset radii and also channel radii can be left in the rough contours given by the crankshaft production process. The bearing grooves produced can be used with standard parts of rolling bearings, especially rolling bearing balls and rolling bearing rings. This enables, for example, preassembly of a crankshaft with connecting rods and especially also with bearing blocks, for example, by the rolling bearing manufacturer. After successful assembly of the crank mechanism, this can be sent, for example, to the engine manufacturer, who has, for example, in the meantime obtained the cylinder heads sent from the foundry and also crankcases along with corresponding, optional, additional crankcase parts. The further assembly of the combustion engine can then be performed on-site in the factory.

Preferably, components are assembled with the cylinder block through various installation procedures. Four different alternatives are listed in brief below, but this list, however, should not be viewed as conclusive. The alternative procedures involve the following arrangements:

1. Closed bearing blocks in rectangular cylinder block channel, preferably thermally decoupled;

2. Divided bearing blocks in rectangular cylinder block channel, preferably thermally decoupled;

3. With main bearing rings in conventional cylinder block channel, for example, not thermally decoupled for the use of aluminum alloys; and

4. Cast parts made from steel in a conventional cylinder block channel with conventional bearing covers. The cast part and the bearing cover have an integrated race, preferably as a direct support for the rolling bodies.

### BRIEF DESCRIPTION OF THE DRAWINGS

Additional advantageous constructions and improvements are to be taken from the following drawings. The features shown there, however, are not limited to the respective construction. Instead, these can be combined to form improvements with features of other constructions from the drawing and also the above description. Shown are:

FIG. 1, a schematic view of a crankshaft with components that are guided via the crankshaft to their installation position,

FIG. 2, a schematic view of a crank mechanism, on which connecting rods and also bearings are preassembled and counterweights are mounted,

FIG. 3, one possibility for assembling the crank mechanism in a crankcase,

FIG. 4, an exploded view of a bearing block, which is suitable, for example, for a bearing to undertake an axial support,

FIG. 5, a preassembled bearing block,

FIG. 6, a connecting rod with a connecting rod bearing, in exploded view,

FIG. 7, a preassembled crank mechanism, which is rigidly installed in a crankcase,

FIG. 8, a cutout from a crankshaft with preassembled connecting rod, wherein, in particular, a roller bearing and a U-shaped support can be used,

FIG. 9, the cutout from FIG. 8 in a quasi-exploded view for explaining the installation,

FIG. 10, a divided rolling bearing cage,

FIG. 11, the rolling bearing cage from FIG. 10 in exploded view,

FIG. 12, a front view of the rolling bearing cage,

FIG. 13, a detailed cutout from FIG. 11,

FIG. 14, a cutout enlargement from FIG. 12,

FIG. 15, further construction for attaching a counterweight to a crankshaft,

FIG. 16, another construction for attaching a counterweight to a crankshaft,

FIG. 17, an example of an assembled crank mechanism with roller bearings,

FIG. 18 shows a first view of the one-piece crankshaft from FIG. 17,

FIG. 19 shows a second view of the one-piece crankshaft from FIG. 18,

FIG. 20 shows a connecting rod from FIG. 17 in a first view,

FIG. 21 shows a connecting rod from FIG. 17 in a second view,

FIG. 22 shows an example of inserting a crank mechanism with a one-piece crankshaft and one-piece connecting rod into a crankcase,

FIG. 23 shows a view of a one-piece crankshaft with attached counterweight and roller bearings, which are each shown with dashed lines in a sectional view,

FIG. 24 shows as an example a possible first configuration of an insertion of a piston into a cylinder liner,

FIG. 25 shows an enlargement of an area encircled with dashed lines in FIG. 24,

FIG. 26 shows an exploded view of the components shown in FIGS. 24 and 25,

FIG. 27 shows a second possibility for inserting a piston into a cylinder liner,

FIG. 28 shows a first tightening band,

FIG. 29 shows an enlargement of a cutout from the first tightening band from FIG. 28,

FIG. 30 shows an inserted tightening band, which compresses the piston ring, in order to be able to insert the piston into a cylinder liner,

FIG. 31 shows an enlargement of an area encircled with dashed lines in FIG. 30,

FIG. 32 shows an example possibility for detaching a tightening band after inserting the piston into a cylinder liner, and

FIG. 33 shows an exploded view of the components taken from FIG. 30.

### DETAILED DESCRIPTION OF THE PREFERRED EMBODIMENTS

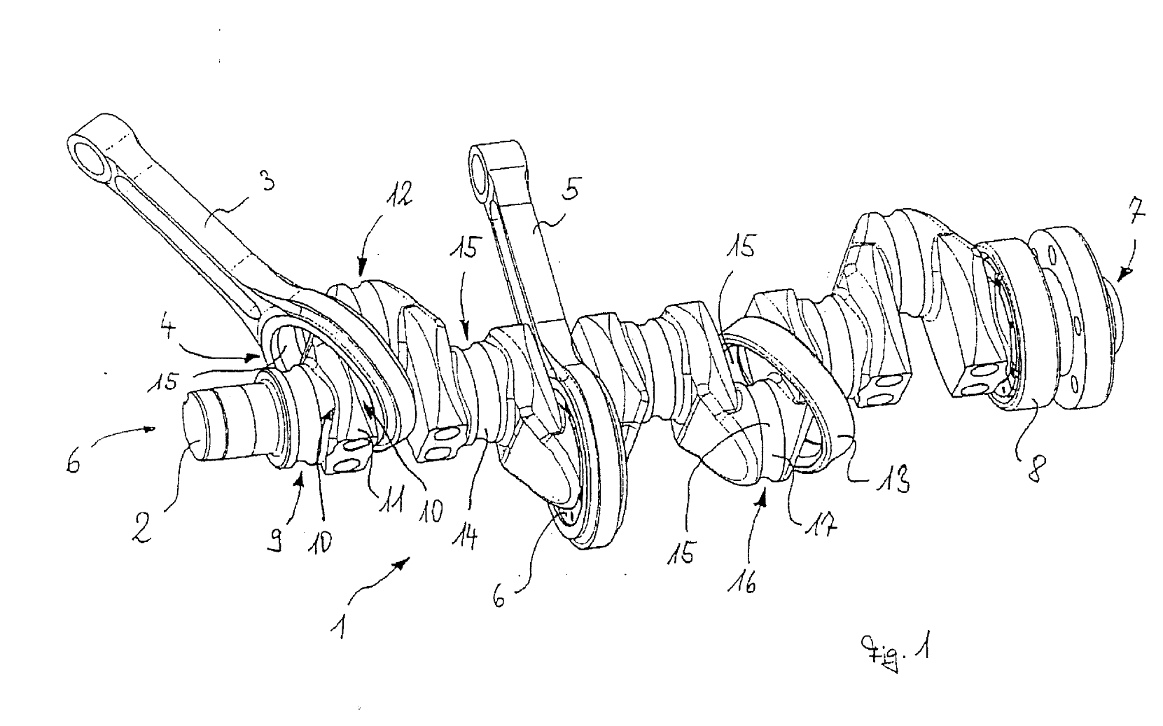

FIG. 1 shows a crank mechanism 1 with a one-piece crankshaft 2. A one-piece connecting rod 3 is inserted at an angle to the crankshaft 2. The dimensioning of the one-piece crankshaft 2 is here matched to an opening 4 in the connecting rod, so that the connecting rod 3 can be guided via the crankshaft 2 into its position. A second connecting rod 5 has already been guided, as an example, to its end position and provided with a corresponding bearing 6. The bearing 6 is here preferably a rolling bearing, especially a ball bearing. The connecting rods 3, 5 thus have been mounted from a front end 6 of the crankshaft. In turn, a rear main bearing 8 has already been mounted on a rear end 7 of the crankshaft 2. The crankshaft 2 has, for example, in an area of a main bearing peg 9 a rounded section at the transition to a web 11. A rounded section 10 is in turn provided at the further transition of the web 11 to a connecting rod bearing track 12. Through skilled mounting of the connecting rods 3, 5 and also bearing rings 13 it is possible to provide the one-piece crankshaft 2 with one-piece connecting rods 3, 5. For the use of one-piece bearing blocks, these are to be threaded on, for example, via the bearing rings before the crankshaft assembly. As shown, the crankshaft is provided completely with rolling bearings, and in particular with ball bearings. Therefore, an inner track 14 of a main bearing has a circular groove 15. A second inner track 16 of a lifting pin bearing 17 is likewise shaped as a circular groove 15. As a counterpart to the corresponding inner tracks 14, 16, the bearing ring 13 or the connecting rod 3 each has a circular groove 15. The type of rolling bearing can be determined through the geometry of the groove 15. For example, these can be ball bearings, roller bearings, needle bearings, angular contact bearings, and also thrust bearings.

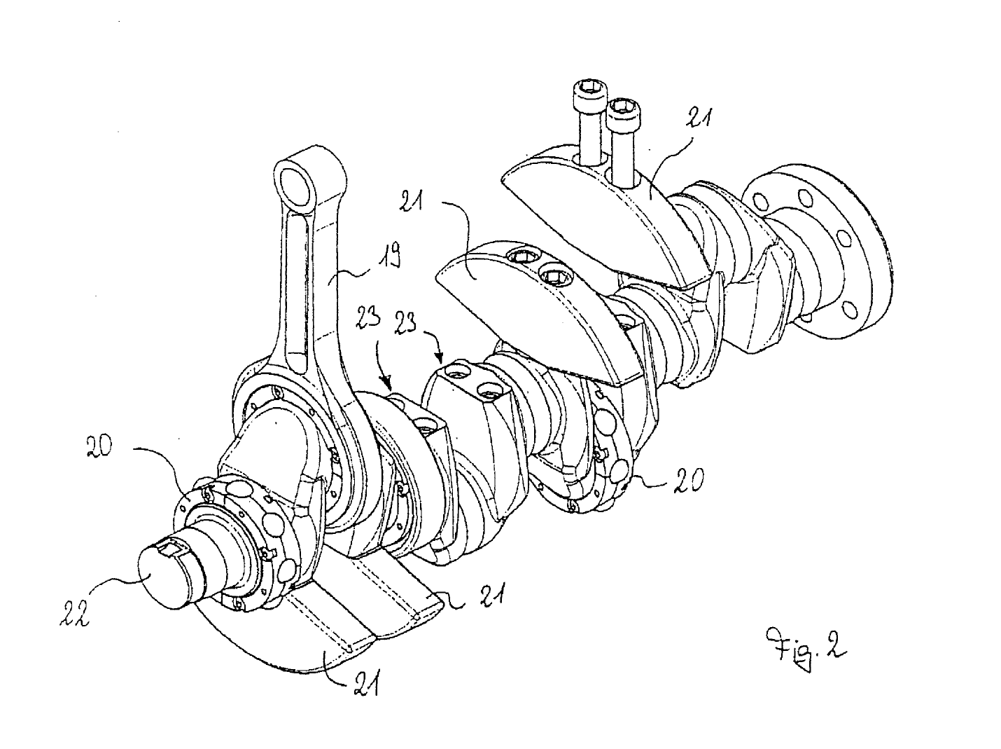

FIG. 2 shows a second crank mechanism 18. The connecting rods 19 and also the main bearings 20 are preassembled on the second crank mechanism 18. The precise assembly of connecting rods 19 and also main bearings 20 is discussed below. As can be discerned from FIG. 2, counterweights 21 are also screwed to the crankshaft 22. For this purpose, the appropriate webs each have two parallel blind holes. The counterweights 21 can then be placed on the webs 23, for example, with a positive fit. The counterweights are fixed with a defined tightening torque by means of corresponding bolts, which preferably have an internal hexagonal screw head.

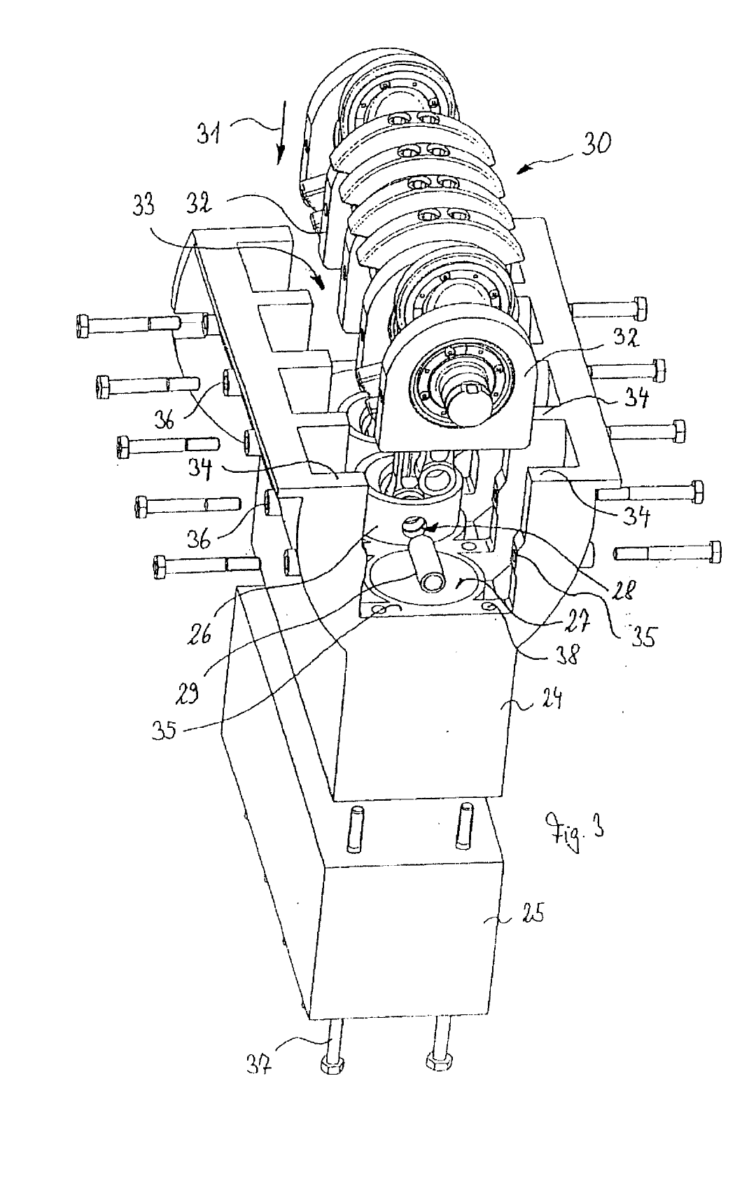

FIGS. 3 and 4 show in a schematic view a possible assembly of a crank mechanism using the example of a four-cylinder in-line engine using ball bearings.

FIG. 3 shows a crankcase 24*, onto which a cylinder head 25 is bolted. In the crankcase 24, pistons 26 are equipped with piston rings not shown in more detail, especially scraper rings, of a given number and inserted from above into a cylinder liner 27. Thus, as shown, the inserted pistons 26 are pushed past the UT [bottom dead center] position, so that a bore 28 for a piston pin 29 emerges from the cylinder liner 27. By means of a lifting tool, not shown in more detail, the preassembled crankshaft 30 can be held in its position, wherein the two inner connecting rods of the four connecting rods are arranged at the UT position. After the piston pins 29 are inserted and have been secured on the piston pin 29 by means of retaining rings, the crankshaft 30 can be pushed by ca. one-half a piston stroke in the direction of arrow 31. Simultaneously, the crankshaft is rotated by ca, 90°. Therefore, the outer pistons can now be assembled in analogous fashion to the inner pistons. This means that first the inner pistons are fixed to the crank mechanism, before the outer pistons. For a six-cylinder in-line arrangement, in turn, the various pistons must be mounted so that sufficient clearance is provided for inserting each piston pin. After the pistons 26 are completely mounted on the preassembled crankshaft 30, the crank mechanism can be moved further in the direction of arrow 31 until each bearing block 32 comes into contact with the cylinder block 24. The cylinder block 24 has a rectangular channel 33 for this type of assembly. The rectangular channel 33 is formed by means of aprons 34. The aprons 34 have, in turn, mating surfaces 35. The mating surfaces 35 are preferably milled. In particular, radial mating surfaces 35 are provided through which longitudinal holes 36 run. In this way, the bearing blocks 32 are each fixed laterally in the crankcase 24 by means of a corresponding screw connection. After this screw connection is tightened with defined tightening torque, the cylinder head 25 can be positioned. The cylinder head bolts 37 are likewise tightened with a defined tightening torque. The cylinder head bolts 37 preferably extend such that they can be screwed into the corresponding bearing blocks 32 by means of corresponding bores 38 running through the crankcase 24. In this way, a flow of forces via the cylinder head bolts into the crankcase can be closed. The preassembled engine can be seen, for example, from FIG. 7.
*[Editor's note: This is actually a combined block and crankcase, and called by either name in the specification.]

FIGS. 4 and 5 show the assembly of a one-piece bearing block 38. The bearing block 38 is constructed here as a fixed bearing. For this purpose, first a first retaining ring 39 is inserted into the bearing block 38. Then, for example, a preassembled rolling bearing, in this case a ball bearing 40, is inserted in the bearing block 38 flush against the retaining ring 39. For additional restraint, the ball bearing 40 is fixed with a second retaining ring 41 in the bearing block 38. Therefore, the example of the preassembled bearing block 38 shown in FIG. 4 is given as a fixed bearing.

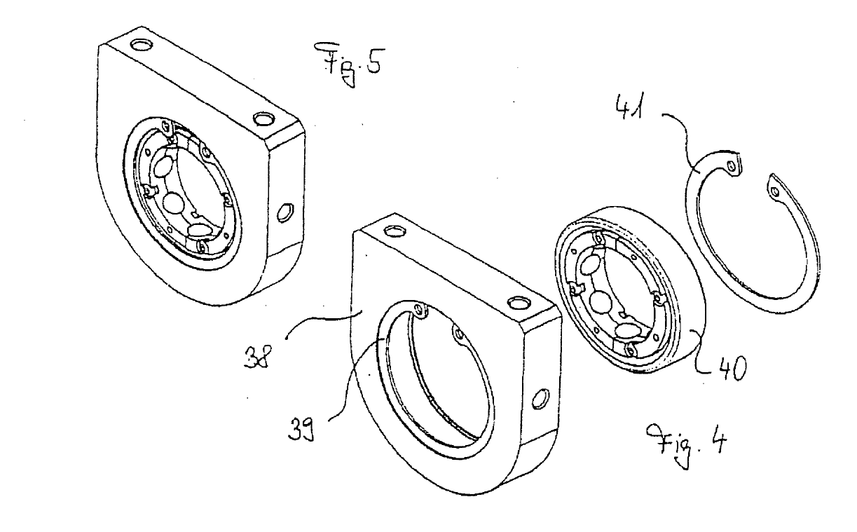

FIG. 6 shows, on the one hand, a one-piece connecting rod 42 in an exploded view. On the other hand, the assembly of an example rolling bearing for the connecting rod 42 is shown from the exploded view. The rolling bearing is, in turn, a ball bearing 43. A cage 44 has four 180° segments 45. The separating joints 46 of the segments 45 are each offset by 90°. In one assembly, this produces an equal operating behavior as a cage closed all around. Cage halves are joined in the installed state by means of screws, rivets, or welds. According to a first possibility, a first cage half is inserted into the connecting rod 42, and then the balls 47 are inserted and then enclosed by the second cage half. Due to the separation of the cages into segments, there is the possibility of arranging these first on the connecting rod when the connecting rod 42 has been mounted over the crankshaft to its position. In addition there is the possibility that cage segments could be clipped to each other, for example, by a corresponding groove-tongue fit, by a hook shape in the form of pins, etc. For this purpose, different snap connections as well as puzzle profiles with an undercut can be used. Preferably, the cage segments are secured in the axial and/or radial direction, for example, by a screw connection, adhesive, or the like. In addition to steel and aluminum, the cage material can also be plastic. Sheet-metal cages can be used and also stamped profiles. According to a second possibility, the balls are first of all inserted, these are aligned, and only then is the cage segment inserted, with which the balls are held in their position. In particular, a higher number of balls can be inserted with this method. There is also the possibility of using a closed cage which has no segments.

FIG. 7 shows a preassembled crank mechanism, in a crankshaft housing, that has been mounted according to the procedure described in FIG. 2. In addition to the possibility described in FIG. 2 for installing a crankshaft into the engine, there is the possibility that first the pistons are equipped with the corresponding piston rings and are mounted on the connecting rods. Then the complete crank mechanism can be inserted into the cylinder block, in that the pistons are inserted from below into the cylinder liners. Here, the pistons can in particular also be inserted simultaneously. For this purpose, an outlet of a cylinder liner is provided with a circular insertion taper. This prevents catching of the piston rings. Then the cylinder head bolts are tightened, so that the engine is assembled.

According to another construction, the crankshaft is to be housed in the engine block, as is the case, for example, in a conventional slide-supported engine with bearing covers screwed on from below. Here, the assembly can be performed, in principle, as described in FIG. 2 or as above. However, the bulkhead walls are to be omitted so that the pistons can extend significantly past the UT position or can be inserted from below into the engine block. For this purpose, inlet tapers for the piston rings are necessary for the assembly from below into the cylinder liners. The cylinder head and also bearing cover can both be fixed by means of a common screw connection or also separately.

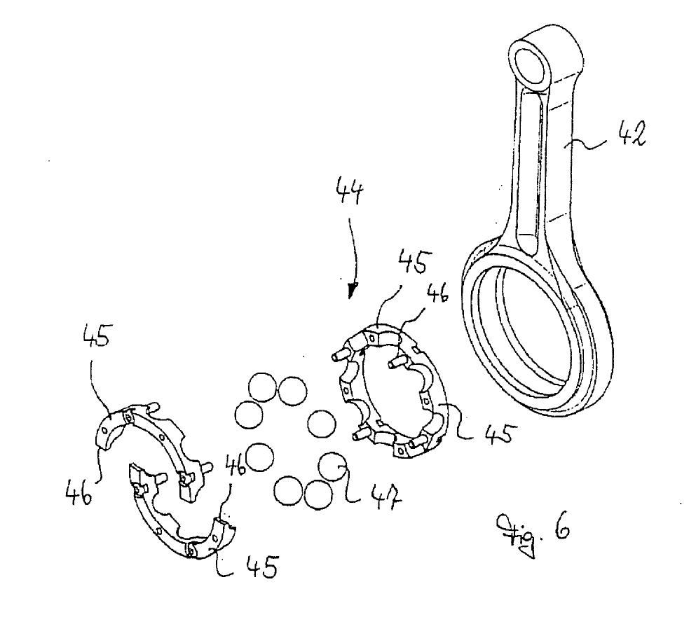

FIG. 8 shows a construction of a crank mechanism 48 that has an especially small construction. It is therefore possible to be able to use an extremely small installation space, which is also provided with a one-piece crankshaft 49 and one-piece connecting rod 50. For this purpose, the webs 51 are provided with short tapers 52, without, however, rounded sections, as emerges, for example, for the crank mechanism of FIG. 1. Through the use of a roller bearing for the crank mechanism 48, a higher load capacity can be achieved. Furthermore, there is the possibility that a combination of roller and ball bearings can be used. Due to the use of roller bearings, the rolling body tracks each have a cylindrical form 53 on the journals and in the connecting rods. An axial guidance of a roller cage 54 is realized by the connecting rod 50 and main bearing 55 by means of adjacent crank webs 56. An axial guidance of the connecting rod 50 can be realized both via the crank webs 56—a so-called bottom guide—but also by the pistons, not shown in more detail—a so-called top guide. In particular, which of the two guides is used is selected according to the purpose of use. For a bottom guide, for example, one or more grooves, slots, or bores are formed for a lubricant feed to the crank webs and a crank pin bearing in the connecting rod eye. Also, additional side bronze discs or hardened steel discs can be attached. For a top guide, for example, slots or the like in the piston boss for lubrication can be eliminated. For guiding the connecting rod between the piston bosses, hardened steel rings with angled cross sections are preferably used that are seated on the piston pin with small radial clearance. For example, the guide surfaces can be lubricated by means of side lubricating grooves. According to one improvement, neither the crankshaft nor a connecting rod has an oil bore for lubrication, independent of the type of guide.

FIG. 9 illustrates an assembly of a roller bearing on the crank mechanism 48 from FIG. 8. For this purpose, a first roller cage half 57 is pushed axially in the arrow direction 58 over the crank 59 into the connecting rod 50. The equivalent procedure takes place with respect to the main bearing 55, likewise with a first roller cage half 57. After each roller cage half 57 has been pushed on, these are each rotated by 180°. Then a second roller cage half, not shown in more detail, is likewise pushed axially into the connecting rod 50 or into the main bearing 55. This leads to a positive-fit dovetail connection 60. To prevent subsequent axial displacement, the corresponding cage halves are secured against each other by means of screws or rivets. According to another construction, the first roller cage half 57 is inserted after the second roller cage half has already been previously inserted in the main bearing 55. For example, the second roller cage half can have already been arranged in the crankshaft through threading of the connecting rod over the crankshaft. To guarantee the ability to assemble the roller cage halves, which can also have differently divided roller cage segments, preferably a diameter of a crank in an outer region 61 is smaller than a diameter of the corresponding journal 62. The periphery of the outer region 61 is directed especially according to a circumferential angle of each cage segment that is used. In the example shown in FIG. 9, this equals 180°,

Joining the roller bearing cages can be done in various ways. In addition to braces, rivets, and screws, for securing the cage halves against axial migration, adhesives, peening, and/or welding can also be used.

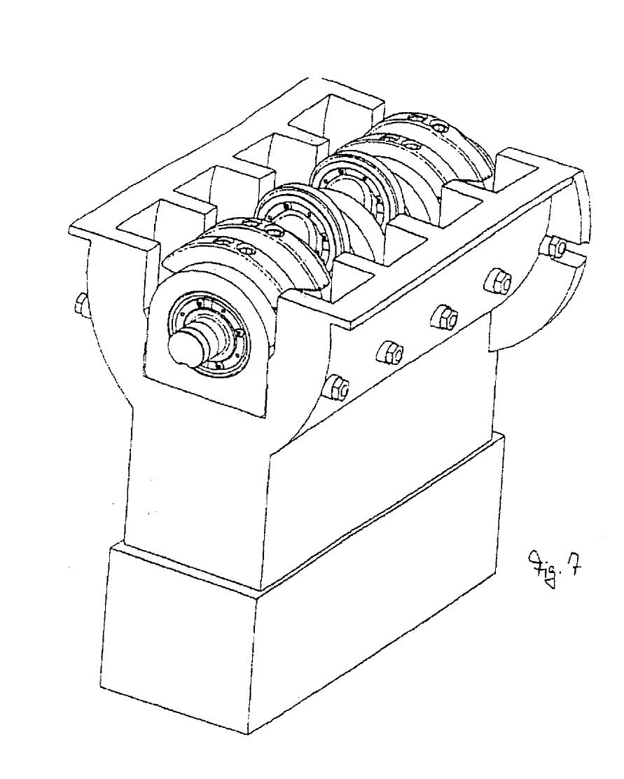

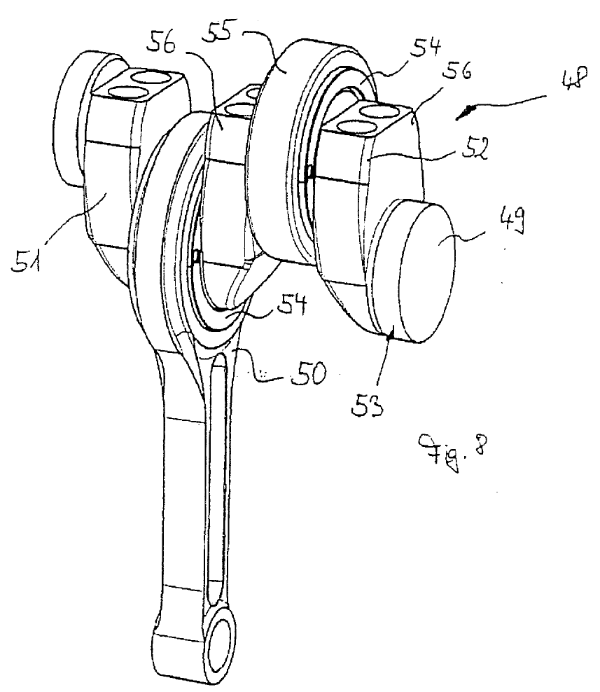

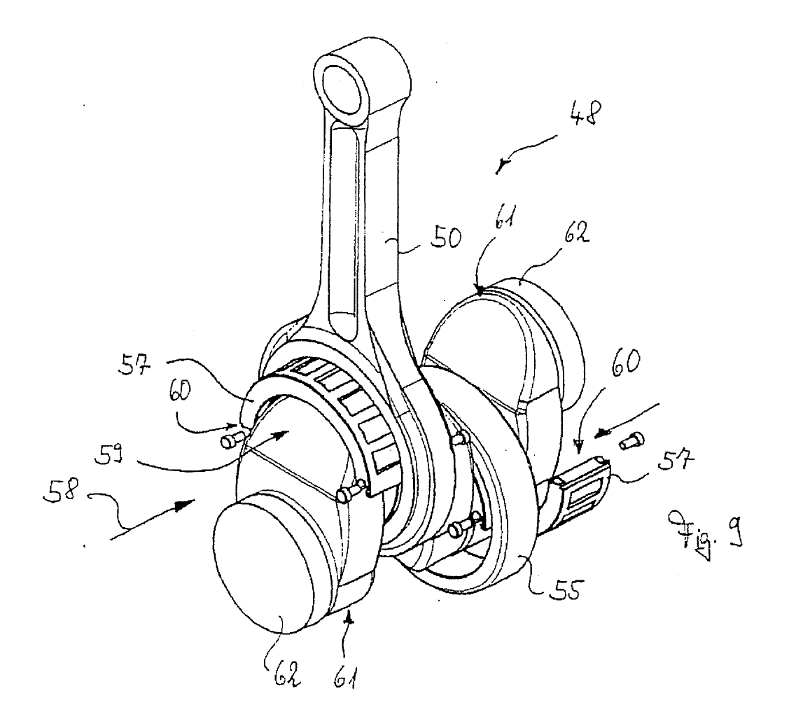

FIGS. 10 to 14 give the preferred connection of cage segments in detail. FIG. 10 shows a representation of a positive-fit connection of a first cage segment 63 to a second cage segment 64. Rollers 65 are arranged in the cages. However, these can also be balls, needles, or the like. In addition, both cage segments 63, 64 have a dovetail connection 66 as a positive-fit connection. FIG. 11 gives the segmented construction of the cage can be taken in more detail. The first cage segment 63 is here separated from the second cage segment 64. The dovetail connection 66 and the geometry of each cage segment 63, 64 are shown. Here it should be noticed that each cage segment has two grooves on one end and two tongues on the other end. This produces the most uniform loading possible over the dovetail connections 66. Both cage segments 63, 64 are preferably fixed to each other by screw connections. However, rivet connections can also be provided. FIG. 12 shows the joined cage 67. In addition to segments that each have linking elements over 180°, other segment sizes can also be used. FIG. 13 shows the dovetail connection 66 again in an enlargement. This also emerges in an enlargement in a front view from FIG. 14.

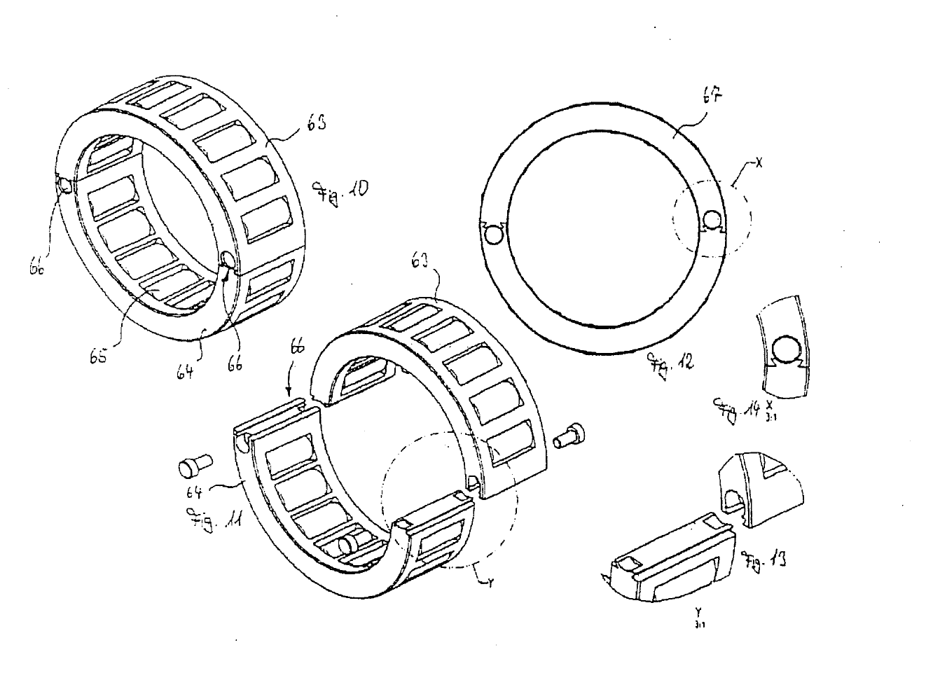

FIG. 15 shows a cross section through a crankshaft 68. One surface of the crankshaft has a flat surface 69 on which a counterweight can be attached. The flat surface 69 is preferably milled. In particular, one or more bores 70 can be formed in this surface, for example, as mating bores or for screw connections. The flat surface 69 can also be used to achieve a positive fit and/or a non-positive fit between the crankshaft 68 and the counterweight.

FIG. 16 shows another cross section through a different crankshaft 71. The surface of the crankshaft 71 has two planes 72, 73 that are arranged at an angle to each other, and that preferably form a gable. However, the planes 72, 73 can also be V-shaped, without meeting each other. In addition, there is also the possibility that other surfaces, especially planes, will be arranged between the two planes 72, 73. Therefore, a surface can be formed, for example, with a polygonal edge, with a groove, and/or a raised section. Each plane can have one or more bores, for example, as mating bores or for screw connections. The surfaces can also be used in combination for achieving a positive fit and/or a flow of forces between the crankshaft and the counterweight.

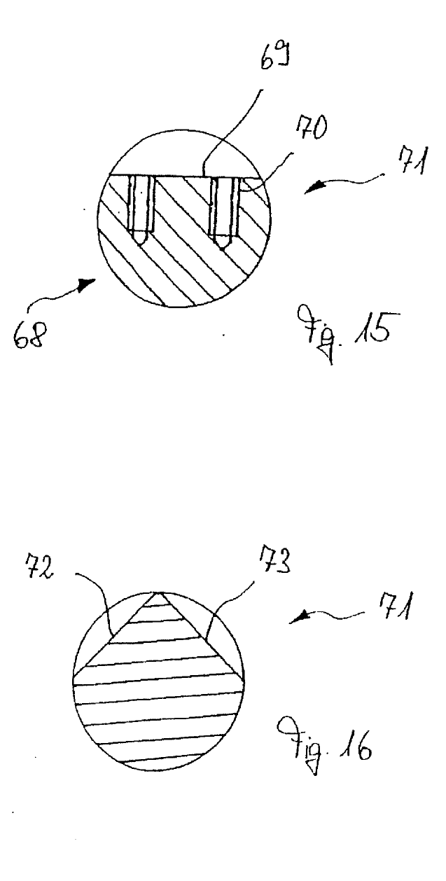

FIG. 17 shows, as an example, another crank mechanism construction, wherein dimensions and characteristic numbers are further specified for this crank mechanism construction. These are not limited, however, to the present crank mechanism, especially the shown roller bearing crank mechanism 74. Instead, the dimensions and also characteristic numbers or regions can be used for other rolling-bearing-supported crank mechanisms.

The roller bearing crank mechanism 74 according to this construction does not differ from an assembly in a ball-bearing crank mechanism. A holder 75 for one or more counterweights is preferably provided with self-centering, for example, as a V-profile constructed, for example, with an angle of 120°. This shape preferably requires no use of fitting aids such as, for example, pins and/or sockets. Fitting aids such as pins and/or sockets are preferably used in straight contact surfaces that do not have self-centering. In the assembly, the counterweights are pressed axially against the contact surface 76 and then screwed on. Likewise, characteristics for this crankshaft are the specially shaped first inclined surface 77 and second inclined surface 78 as well as the recess clearance 79, which preferably is also at an incline. The arrangement of these surfaces at transitions in this construction guarantees free travel during the threading on of the connecting rods and especially the bearing blocks.

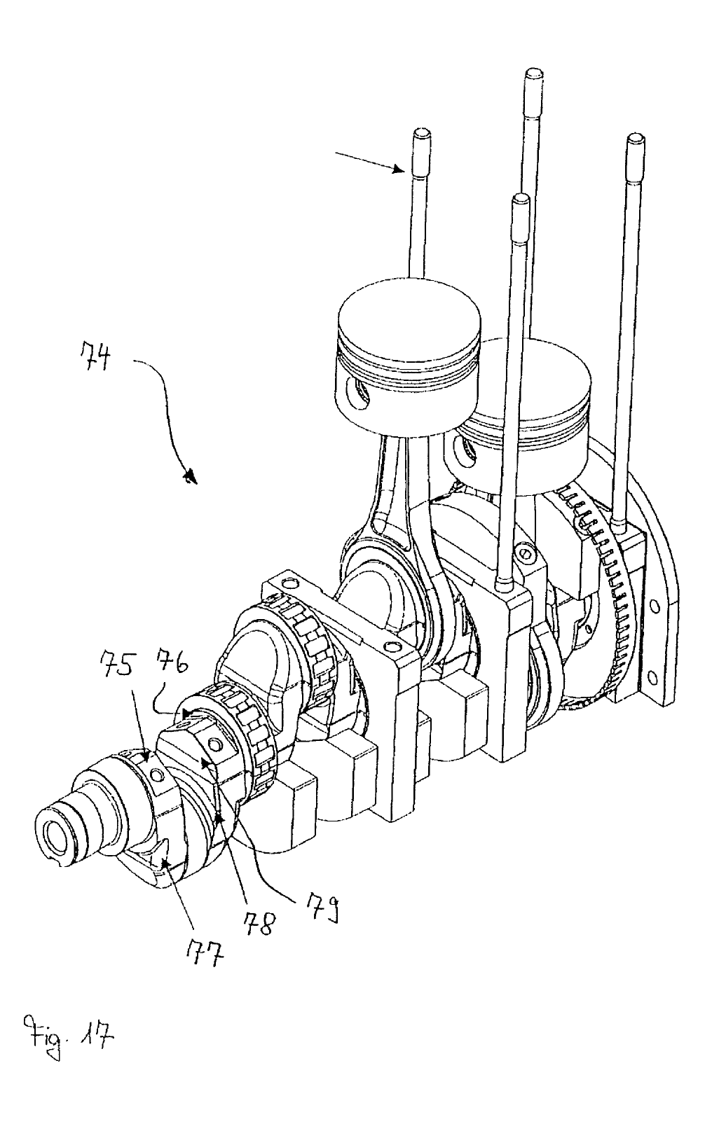

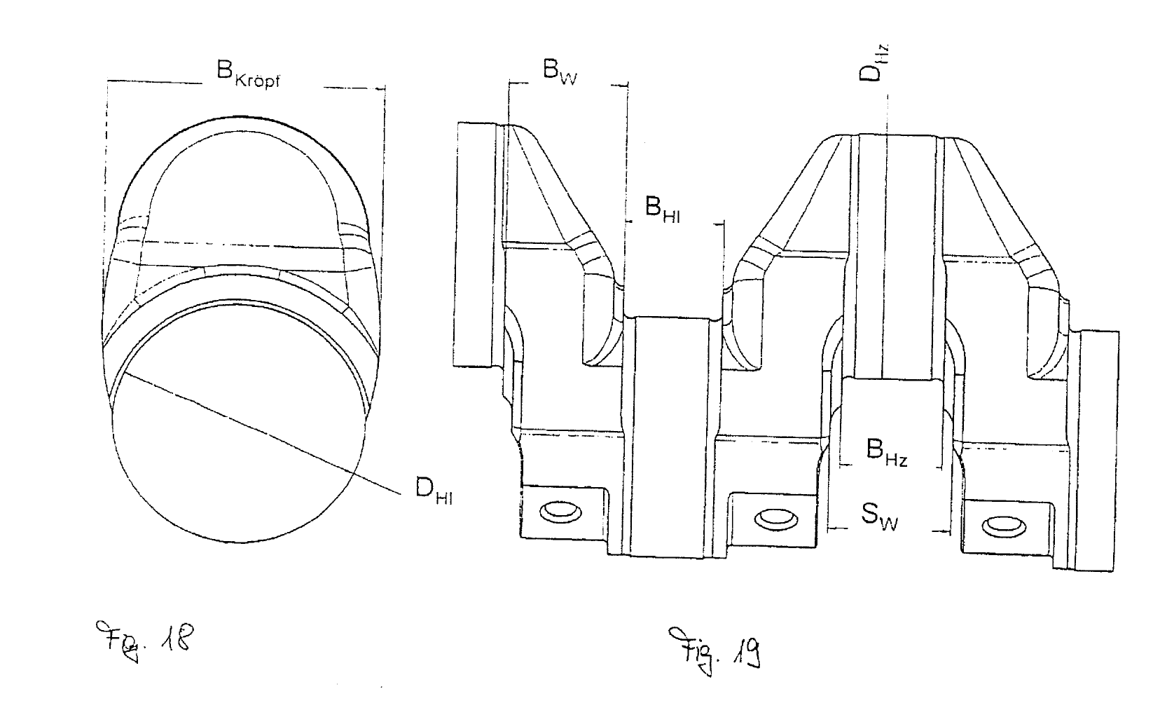

According to a preferred construction, for a crank mechanism with sufficient stiffness, the following dimensional relationships, whose values can deviate by ca. +/−20%, are provided for the installability, especially for the threading on of the connecting rods and the bearing blocks. The values specified below are given in more detail in FIGS. 18, 19, 20, and 21. An example crank mechanism and the associated components emerge from these figures.

Crankshaft:

D_{Hz}/D_{HL}=1 (preferably value 1, if D_{Hz}/D_{HL}≠1 the greater diameter is the determining factor)

B_{Crank}/D_{Hz}=1.1

B_{W}/D_{Hz}=0.48

S_{W}/D_{Hz}=0.48

B_{Hz}/D_{Hz}=0.4

Piston stroke/D_{Hz}=1.55

Connecting Rod:

D_{Pl}/dₚₗ=1.29 . . . 1.36 (max. 1.4)

d_{Pl}/D_{Hz}=1.28 . . . 1.32

B_{Pl}/D_{Hz}=0.38

Bearing block (not shown, dimensions, however, as for connecting rod):

B_{Bearing block}/D_{Hz}=0.36

d_{Bearing block/D}_{Hz}=max. 1.4 (relative to thinnest position)

Rolling Body:

D_{Roller}/D_{Hz}=0.14 . . . 0.18

D_{Roller}/Length_{Roller}1.25 . . . 1.9

The dimensional deviations of +/−20%, preferably of less than +/−5%, manifest themselves in the assembly clearance of connecting rods and bearing blocks, which should preferably equal at least 0.4 mm absolute value in at least one position, preferably in at least most positions, and especially in all positions during the threading-on, so that easy assembly is guaranteed.

For a sufficient dynamic load rating of 45 kN, for example, for a 4-cylinder PKW [passenger car] engine, preferably 14 to 20 rollers are used, wherein the preferred roller size should lie between 7 and 9 mm.

The dimensional relationships valid for the crankshaft supported by rollers can likewise be applied for the ball-supported crankshaft, in which case the ball track diameter minus twice the groove depth is to be used as the outer ring diameter.

FIG. 22 shows, using an example in exploded view, a possibility of assembling a cylinder block with pistons and crank mechanism next to ladder frames. The assembly principle of the crank mechanism in the cylinder block and the piston assembly are preferably identical to that in a ball-supported version according to this embodiment. To relieve the load on the tension rod in terms of torsion during the tightening, preferably stay bolts are to be used in FIG. 171 [sic], which can be fixed by a locknut for torsion-free tightening via a hexagonal socket in the head. A second fixing of bearing blocks, especially for preventing oscillations in the crankshaft direction, is preferably performed by means of a ladder frame 81, as emerges from FIG. 22 in an example construction. The ladder frame 81 is connected to the bearing block 83 via the [internal] threads 82. For the sake of simplicity, the necessary screws are not shown in more detail. The ladder frame 81 is connected to a not-shown oil pan flange of the cylinder block 84 by screw connections, not shown in more detail. For space reasons, if, for example, an outer bearing block 85 cannot be connected via the ladder frame 81 due to an oil pan becoming flatter towards the back, then, for example, attachment to the cylinder block via a housing cover 86 or through a side screw connection is possible.

The bearing blocks 83 shown in FIG. 22 preferably have a directly machined running surface for direct support in the bearing block. Therefore, it is also possible to keep the bearing blocks 83 and necessary components small.

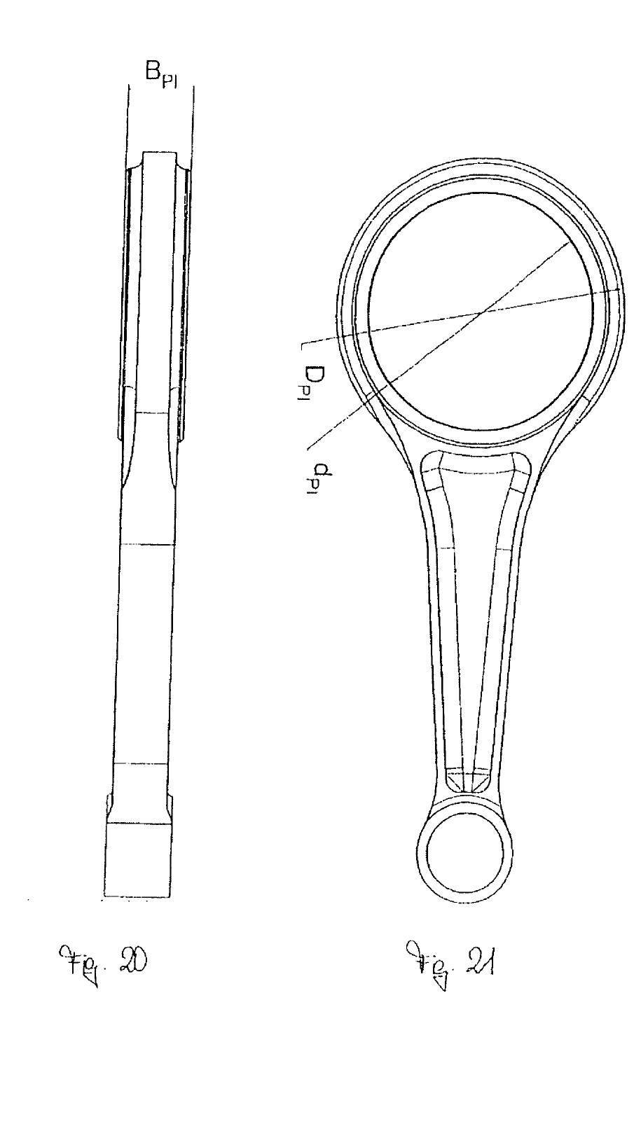

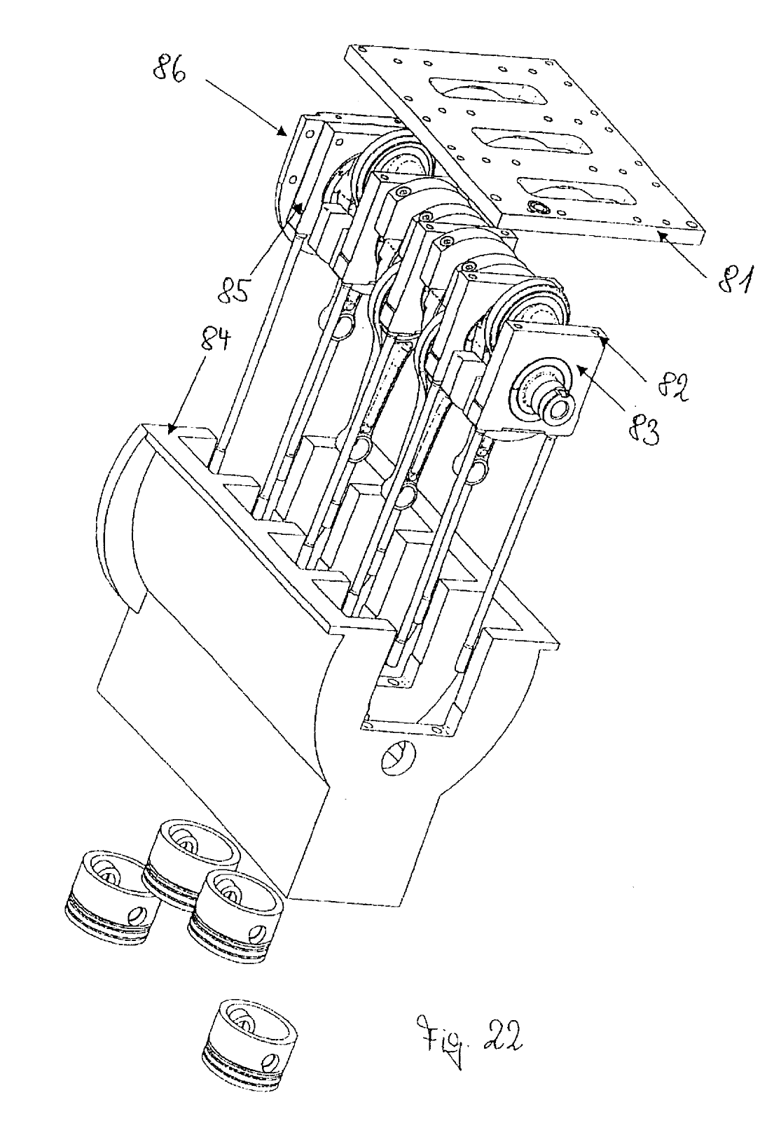

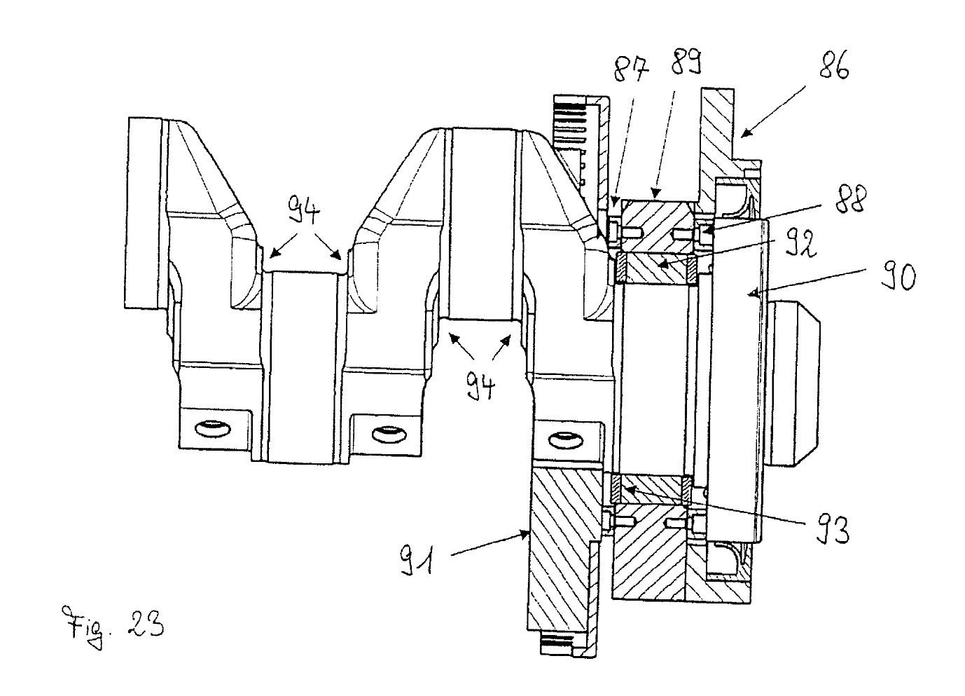

FIG. 23 shows an example construction of the crank mechanism, in which a preferred axial guidance of the crankshaft is shown.

The axial guidance of the crankshaft can be taken over by a standard cylindrical roller bearing of the NUP type, which is pushed onto the free end of the shaft. This bearing has guide shoulders in both the outer and inner rings, and these receive a clutch disengagement force and can prevent the crankshaft from axial migration in the clutch direction. The inner ring of the standard bearing is secured against shifting. According to one construction, this is realized, for example, by means of a radial shrink fit or according to another construction by means of axial tensioning, for example, with a control wheel or chain sprocket.

Instead of the shown cylindrical roller bearing, a ball bearing can also be used.

Axial fixing can also be realized via sliding rings 87, 88, especially made from bronze, which are fixed, especially screwed, for example, on the housing-attached bearing block 89. The clutch disengagement force is transferred from a clutch flange 90 to the sliding ring 88. For fixing the crankshaft in the flywheel direction, the counterweight 91 contacts the sliding ring 87. The lubrication of the sliding rings and also the enclosed roller bearing 92 in-between with the cage 93 is realized, for example, by means of an oil bore with collected or pressurized oil that is not shown in more detail.

The axial support or fixing by means of sliding rings can be arranged as shown both on the clutch side or else also on the free end of the shaft or also on every other main bearing. Instead of the sliding rings, needle bearing collars can also be used.

Likewise, a combined axial support can be used with a sliding ring, which receives the clutch disengagement force, and with a cylindrical roller bearing of the type NJ with a shoulder that fixes the crankshaft relative to the clutch side.

Furthermore, a cage guide of the rolling bearing can be seen in FIG. 23. The axial cage guidance in the main and connecting rod bearings is realized by running surfaces 94 on the insides of the crank webs. The radial guidance of the connecting rod bearing cage is realized based on centrifugal force via the outer track in the connecting rod. A radial guidance of the main bearing cage can be effected via the journals as an inner track or by means of suitable shaping of the cage pockets through support on the rolling bodies such that the cage does not contact the inner and outer running surfaces.

Below, preferred values that can be used for various rolling bearings are specified for the crank mechanism.

Bearing clearance

| | |
|---|---|
| The running clearance of the cage: | |
| Axial clearance on the crankshaft | 0.008 . . . 0.012 (up to 0.3) * width |
| Radial clearance in connecting rod | 0.003 . . . 0.005 * track diameter |
| | (upper value preferably for light- |
| | metal cages) |
| Running clearance of rollers: | |
| Clearance of roller in cage pocket: | 0.008 . . . 0.02 (up to 0.5) * |
| | roller diameter |
| Axial clearance of roller in cage | 0.01 . . . 0.02 (up to 0.5) * |
| | roller length |
| Main bearing clearance (cold): | Diametrical 0.0004 . . . 0.0008 |
| | (up to 0.025) * journal |
| | diameter (ball bearing clearance |
| | ca. 50% smaller) |
| Connecting rod bearing clearance | Diametrical 0.0001 . . . 0.0003 |
| (cold): | (up to 0.0075) * journal |
| | diameter (ball bearing clearance |
| | ca. 50% smaller) |

These clearance limits have proven to be advantageous in terms of operation. Preferably, main bearing clearance should be between 20 and 80 μm. An upper limit of the individual clearance values can be raised to a 25-fold value as indicated in some cases in brackets.

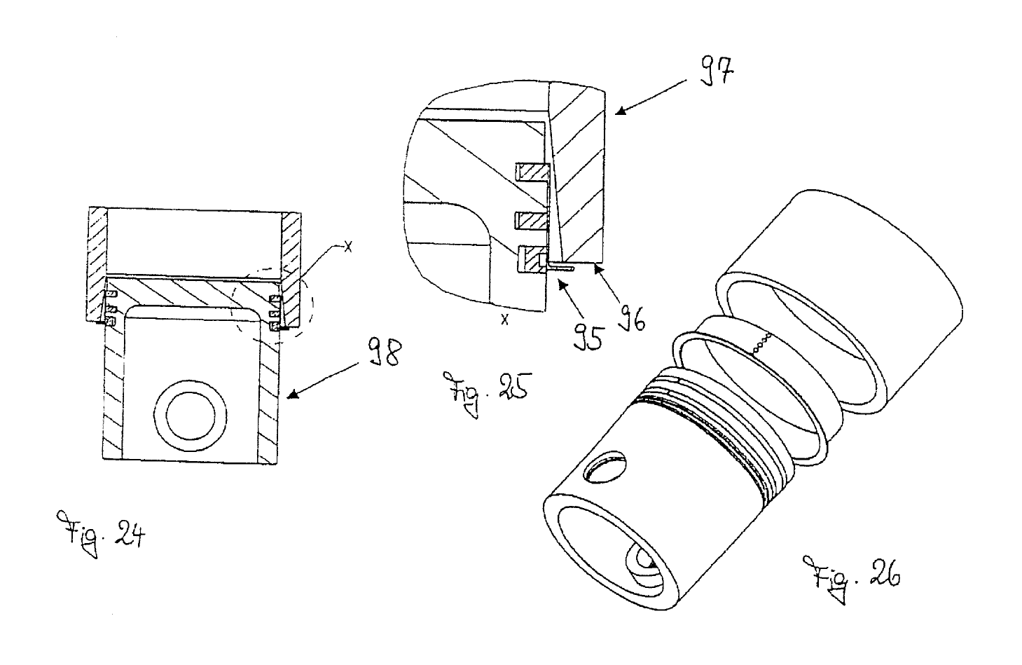

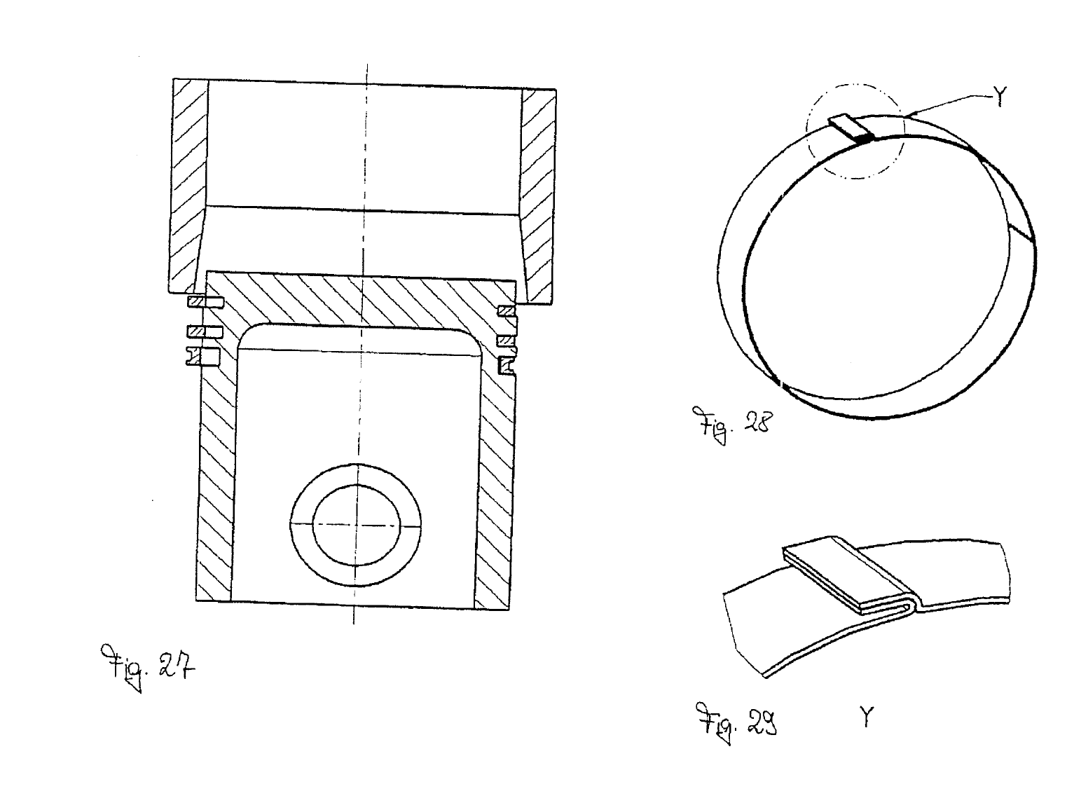

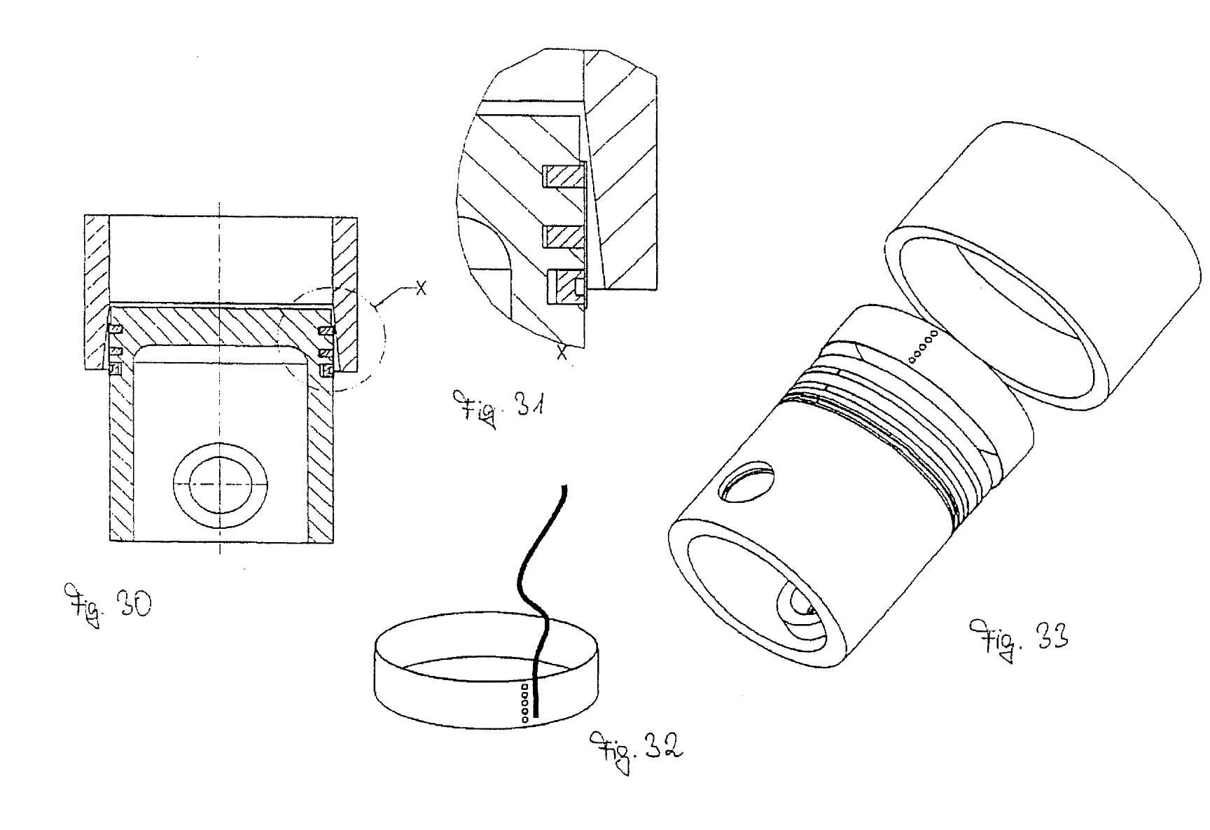

FIGS. 24 to 33 show various possibilities for how a piston can be inserted into a cylinder for such a crank mechanism. For example, for this purpose a piston ring tightening band can be used.

FIGS. 24 and 25 show as an enlargement a use of a tightening band or clamping ring with a collar 95. Thus, the tightening band is stripped automatically from the ring packet of the piston during the insertion process, as soon as the collar 95 contacts an end face 96 of a cylinder liner 97. The tightening band slides over the piston skirt from the piston 98 as soon as the piston 98 has been pushed in completely. The tightening band then over the connecting rod can then be pulled off from the outside with a hook or cut off with shears. A tear line can also be provided. The tightening band with a collar can be produced either from an angled sheet-metal or plastic band, which is welded or folded at the ends, or can be deep drawn from a sheet-metal ring. Also, a perforation as a desired break point could also be provided, if the strap is not cut.

Likewise, an angled bracket can be used that is attached next to a desired break point on the tightening band or is machined into the folded connection. In cross section, the bracket looks just like the collar 95. As soon as the bracket makes contact, the strap seated tight against the piston is ripped off.

It has proven advantageous for piston assembly from below, as also shown, for example, in FIGS. 27 to 33, to provide an insertion bevel on the cylinder liner or the like. For an assembly of a piston from above, the pistons are provided pushed on with the skirt in an assembly sleeve with a long and wide insertion taper, so that the piston rings are slowly tightened and pushed into their grooves. The insertion taper preferably has, as a maximum diameter, a larger diameter than the pressure-relieved piston rings. The taper itself has a flat angle so that the rings cannot lose their flush position relative to the piston ring groove and so that the piston rings receive the smallest possible axial force.

For the assembly of pistons from below through the cylinder block, an insertion taper for the piston rings is also provided. This is preferably only very short. In this way, the overall height of the engine is prevented from increasing due to the insertion taper. For example, an insertion taper equals a height that is approximately on the order of magnitude of 1 to 1.5 times that of a ring packet height. Preferably, the taper has an angle of 10° maximum. A tightening band is provided in order to tighten the piston rings to a minimum diameter. The minimum diameter does not have to be the smallest possible diameter. It can be sufficient to press the piston rings far enough that they can be inserted into the taper. Then the tightening band can be removed. For example, for this purpose, a rip cord can be pulled that severs the tightening band and thus divides it for removal. Then the piston can be pushed farther into the cylinder. The rip chord or another separating means can be bonded, for example, in the form of a plastic or sheet-metal strip, welded into the material or wrapped around the tightening band. A controlled tearing of the tightening band is possible, for example, by means of perforations or other types of break points.

Preferably, the tightening band is composed of a thin sheet or plastic. Advantageously, the thickness of a tightening band is less than 0.2 mm. In particular, it can be pulled in one piece as a kind of heat-shrinkable sleeve over the ring packet from the inserted piston rings. An open strap can also be used, which can be closed after tangential tightening. The closure can be performed, for example, through bonding or fusing of overlapping strap ends. Another possibility exists through folding, wherein the fold also can be bonded or fused. Preferably, the fold is flattened after being formed.

The present concept of a crank mechanism with a one-piece crankshaft and also one-piece connecting rods, as well as, in particular, one-piece bearing blocks, can be used not only for combustion engines for motor vehicles, but also, for example, in combustion engines for vehicles in general, for example, for motorcycles, for generators, for work machines in general, which use a corresponding crank mechanism. For internal combustion engines, such a crank mechanism can be used for in-line engines, V-engines, combustion engines operating according to the Otto principle and also according to the Diesel principle. Applications can also be pumps, compressors with crank mechanisms or the like. In addition, there is also the possibility of using the crank mechanism for stationary applications. The crank mechanism can also be used for a current generator. For example, the crank mechanism can be applied to a generator. Preferably, the crank mechanism is used where, in the case of a rolling bearing application, there is a great potential for reducing [fuel] consumption.

We claim:

1. A crank mechanism comprising:
a one-piece crankshaft; and
at least three one-piece connecting rods, said at least three one-piece connecting rods assembled together with each other in a non-destructive way.

2. The crank mechanism according to claim 1, wherein said crank mechanism has at least one one-piece bearing block, said at least one-piece bearing block supporting the crankshaft.

3. The crank mechanism according to claim 1, wherein said crank mechanism has only one-piece bearing blocks.

4. The crank mechanism according to claim 1, wherein said crank mechanism has at least one rolling bearing for the crankshaft.

5. The crank mechanism according to claim 4, wherein said rolling bearing comprises at least one ball bearing and/or one roller bearing.

6. The crank mechanism according to claim 1, wherein said crankshaft is supported exclusively by rolling bearings.

7. The crank mechanism according to one claim 1, wherein said crank mechanism has at least one rolling bearing and one sliding bearing for the crankshaft.

8. The crank mechanism according to claim 4, wherein said at least one rolling bearing has a cage made from joined cage segments that are dimensioned so that assembly of the rolling bearing on the crankshaft is possible.

9. The crank mechanism according to claim 1, wherein said crankshaft has a rounded section at a transition between a bearing journal and a web, such that the one-piece connecting rod can pass this section.

10. The crank mechanism according to claim 1, wherein counterweights, which are arranged, in particular, as separate counterweights, are arranged on the crankshaft.

11. The crank mechanism according to claim 10, wherein said counterweights are arranged detachably, in particular, screwed onto the crankshaft.

12. The crank mechanism according to claim 1, wherein said crank mechanism is inserted into a crankcase, having rectangular channel for receiving bearing blocks.

13. The crank mechanism according to claim 12, wherein said bearing blocks are fixed laterally.

14. The crank mechanism according to claim 2, wherein said at least one bearing block of the crankshaft is fixed by a cylinder head screw.

15. The crank mechanism according to claim 1, wherein a rolling bearing, especially a ball bearing, has an insertion slot at the edge for inserting rolling bearing bodies.

16. The crank mechanism according to claim 1, wherein a motor vehicle has the crank mechanism in said motor vehicle's combustion engine.

17. A system module of a crank mechanism, comprising:
at least one one-piece crankshaft; and
at least three one-piece connecting rods, said at least three one-piece connecting rods assembled together with each other in a non-destructive way, and said system module providing said at least one one-piece crankshaft for various applications.

18. The system module according to claim 17, wherein said crankshaft has separately attached counterweights, said separately attached counterweights being different for a combustion engine operating according to the Otto principle compared with those for a combustion engine operating according to the Diesel principle.

19. (canceled)

20. A method for producing a combustion engine of a motor vehicle, said method comprising the steps of:
producing a one-piece crankshaft;
producing at least three one-piece connecting rods;
assembling the three one-piece connecting rods and the one-piece crankshaft in a non-destructive manner to form a combination of connecting rods and crankshaft; and
inserting the combination of connecting rods and crankshaft into a crankcase.

21. The method according to claim 20, wherein a one-piece bearing block is arranged on the crankshaft between at least two one-piece connecting rods.

22. The method according to claim 20, wherein rolling bearing bodies are introduced into and secured to at least one connecting rod bearing and/or into one crankshaft bearing for the assembly of the connecting rods and crankshaft.

23. The method according to claim 20, wherein pistons of the combustion engine are connected first to the connecting rods and via the connecting rods to the crankshaft before the pistons are inserted into the appropriate cylinders.

24. The method according to claim 20, wherein pistons of the combustion engine are first inserted into an appropriate cylinder and brought into a defined position before the pistons are connected to the connecting rods and via the connecting rods to the crankshaft.

25. The method according to claim 20, wherein the connecting rods are guided over the crankshaft beginning from a shaft end opposite a clutch flange.

26. The method according to claim 20, wherein one-piece bearing blocks for the crankshaft are produced and used.

27. The method according to claim 26, wherein a plurality of one-piece bearing blocks to be manufactured are stacked and clamped to each other before drilling and milling.

28. The method according to claim 20, wherein a bearing block with a rolling bearing arranged in the bearing block is threaded on the bearing block.

29. A system for producing a crank mechanism comprising:
production of a one-piece crankshaft;
production of at least three one-piece connecting rods;
a first station for non-destructive assembly of said one-piece connecting rods and said one-piece crankshaft into a combination of connecting rods and crankshaft; and
a second station for inserting said combination of connecting rods and crankshaft into a housing.

30. The system according to claim 29, wherein said first station provides a one-piece bearing block arranged on said crankshaft between at least two of said three one-piece connecting rods.

31. The system according to claim 29, wherein said first station for assembling said connecting rods and crankshaft provides rolling bearing bodies to be introduced into and secured in at least one connecting rod bearing and/or in one crankshaft bearing.

32. The system according to claim 29, wherein said second station provides for pistons of said crank mechanism to be first connected to said connecting rods and via said connecting rods to said crankshaft before said pistons can be inserted into an appropriate cylinder.

33. The system according to claim 29, wherein said second station provides for pistons of said crank mechanism to be first inserted into an appropriate cylinder and brought into a defined position before said pistons can be connected to said connecting rods and via said connecting rods to said crankshaft.

34. The system according to claim 29, wherein said first station provides for said the connecting rods to be guided over said crankshaft beginning from a shaft end opposite a clutch flange.

35. The system according to claim 29, wherein said second station is designed such that one-piece bearing blocks for said crankshaft are produced and used.

36. The system according to claim 35, wherein a clamping device is provided in order to clamp a plurality of manufactured, stacked, one-piece bearing blocks with each other before drilling and milling.

37. The system according to claim 29, wherein said system provides for the threading-on of a bearing block with rolling bearings arranged in said bearing block.
